(19) United States
(12) Patent Application Publication
(10) Pub. No.: US 2007/0216307 A1
(43) Pub. Date: Sep. 20, 2007

(54) Plasma display panel

(76) Inventors: Jae-Ik Kwon, Suwon-si (KR); Won-Ju Yi, Suwon-si (KR); Ho-Young Ahn, Suwon-si (KR); Kyoung-Doo Kang, Suwon-si (KR); Dong-Young Lee, Suwon-si (KR); Soo-Ho Park, Suwon-si (KR); Seok-Gyun Woo, Suwon-si (KR)

Correspondence Address: Robert E. Bushnell, Suite 300, 1522 K. Street, N.W., Washington, DC, 20005-1202, US

(21) Appl. No.: 11/643,809

(22) Filed: Dec. 22, 2006

(30) Foreign Application Priority Data
Mar. 6, 2006 (KR) 10-2006-0020951

(51) Int. Cl. H01J 17/49

(52) U.S. Cl. 313/584; 313/585

(57) ABSTRACT

A plasma display panel having an improved exhaustion capacity. The plasma display panel includes a first substrate and a second substrate facing each other, an electrode sheet arranged between the first substrate and the second substrate and partitioning a space between the first substrate and the second substrate into a plurality of discharge cells, the electrode sheet including a plurality of pairs of discharge electrodes arranged within a plurality of barrier ribs, the plurality of pairs of discharge electrodes adapted to generate a discharge in the plurality of discharge cells, the electrode sheet extending throughout a discharge area where a discharge is generated and into a non-discharge area surrounding at least a portion of the discharge area and a spaced layer arranged on portions of the first substrate corresponding to the non-discharge area, wherein at least a portion of the electrode sheet within the discharge area is spaced apart from the first substrate by an exhaustion space and a portion of the electrode sheet in the non-discharge area is arranged between the spaced layer and the second substrate.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on Mar. 6, 2006 and there duly assigned Serial No. 10-2006-0020951.

### BACKGROUND OF THE INVENTION

1. Field of the Invention

The present invention relates to a plasma display panel, and more particularly, to a plasma display panel having an improved exhaustion capacity.

2. Description of the Related Art

Plasma display panels (PDPs) are flat display panels that display images using an electrical gas discharge, and are considered to be the next generation of flat display panels due to good display properties such as thinness, display capacity, brightness, contrast, afterimage, and viewing angle.

The plasma display panel includes a first substrate, pairs of sustain electrodes, a first dielectric layer the sustain electrodes, a protective layer on the first dielectric layer, a second substrate facing the first substrate, address electrodes disposed parallel to each other on the second substrate, a second dielectric layer on the address electrodes, barrier ribs formed on the second dielectric layer, and light-emitting phosphor layers formed on top of the second dielectric layer and sidewalls of the barrier ribs. Since discharge cells are defined and bordered by the barrier ribs, impurity gas remaining in the discharge cells cannot be easily expelled. What is therefore needed is an improved design for a PDP that allows for the exhaustion of impure gases from the discharge cells.

### SUMMARY OF THE INVENTION

It is therefore an object of the present invention to provide an improved design for a PDP.

It is also an object of the present invention to provide a PDP having an improved exhaustion capacity.

According to an aspect of the present invention, there is provided a plasma display panel that includes a first substrate and a second substrate facing each other, an electrode sheet arranged between the first substrate and the second substrate and partitioning a space between the first substrate and the second substrate into a plurality of discharge cells, the electrode sheet including a plurality of pairs of discharge electrodes arranged within a plurality of barrier ribs, the plurality of pairs of discharge electrodes adapted to generate a discharge in the plurality of discharge cells, the electrode sheet extending throughout a discharge area where a discharge is generated and into a non-discharge area surrounding at least a portion of the discharge area and a spaced layer arranged on portions of the first substrate corresponding to the non-discharge area, wherein at least a portion of the electrode sheet within the discharge area is spaced apart from the first substrate by an exhaustion space and a portion of the electrode sheet in the non-discharge area is arranged between the spaced layer and the second substrate.

The non-discharge area of the electrode sheet can surround the discharge area. The spaced layer can be arranged along an edge of the first substrate and can have a closed shape. The PDP can also include further a sealing layer adapted to combine the spaced layer and the second substrate together and to seal within the plurality of discharge cells. The electrode sheet can have a constant thickness. A plurality of grooves can be arranged on a side of the first substrate that faces the plurality of discharge cells. The PDP can also include phosphor layers arranged in the plurality of grooves.

Each pair of said plurality of pairs of discharge electrodes can include a first discharge electrode and a second discharge electrode arranged within ones of the plurality of barrier ribs and spaced apart from each other in a direction perpendicular to the first substrate, each first discharge electrode can cross each second discharge electrode, each first discharge electrode and each second discharge electrode can surround at least one portion of each discharge cell arranged in a predetermined direction. Each pair of said plurality of pairs of discharge electrodes can include a first discharge electrode and a second discharge electrode arranged within ones of the plurality of barrier ribs and spaced apart from each other in a direction perpendicular to the first substrate, each first discharge electrode and each second discharge electrode can extend in a direction parallel to each other, each first discharge electrode and each second discharge electrode can surround at least one portion of each discharge cell arranged in a predetermined direction. The PDP can further include a plurality of address electrodes, each of said address electrodes can be spaced apart from ones of each pair of discharge electrodes in a direction that is perpendicular with respect to the first substrate, each of said address electrodes can extend in a direction that crosses the pairs of discharge electrodes, each of the address electrodes can surround at least one portion of each discharge cell arranged in a predetermined direction.

According to another aspect of the present invention, there is provided a PDP that includes a first substrate and a second substrate facing each other and an electrode sheet arranged between the first substrate and the second substrate and partitioning a space between the first substrate and the second substrate into a plurality of discharge cells, the electrode sheet including a plurality of pairs of discharge electrodes arranged within a plurality of barrier ribs, the plurality of pairs of discharge electrodes adapted to generate a discharge in the plurality of discharge cells, the electrode sheet extending throughout a discharge area where a discharge is generated and into a non-discharge area surrounding at least a portion of the discharge area, wherein at least a portion of the electrode sheet within the discharge area is spaced apart from the first substrate so that a step height is formed in portions of the first substrate corresponding to the non-discharge area of the electrode sheet.

The non-discharge area of the electrode sheet can surround the discharge area. The step height can be arranged along an edge of the first substrate. The first substrate can include a circumference part that surrounds a center part, the circumference part of the first substrate having a greater thickness than that of a center part of the first substrate due to the step height, the plasma display panel can also include a sealing layer adapted to connect the circumference part of the first substrate to the second substrate and adapted to seal the discharge cells within. The electrode sheet can have a constant thickness. A plurality of grooves can be arranged on a side of the first substrate facing the discharge cells. The PDP can also include phosphor layers arranged in the plurality of grooves.

Each pair of said plurality of pairs of discharge electrodes can include a first discharge electrode and a second discharge electrode arranged within ones of the plurality of barrier ribs and spaced apart from each other in a direction perpendicular to the first substrate, each first discharge electrode can cross each second discharge electrode, each first discharge electrode and each second discharge electrode can surround at least one portion of each discharge cell arranged in a predetermined direction. Each pair of said plurality of pairs of discharge electrodes can include a first discharge electrode and a second discharge electrode arranged within ones of the plurality of barrier ribs and spaced apart from each other in a direction perpendicular to the first substrate, each first discharge electrode and each second discharge electrode can extend in a direction parallel to each other, each first discharge electrode and each second discharge electrode can surround at least one portion of each discharge cell arranged in a predetermined direction. The PDP can further include a plurality of address electrodes, each of said address electrodes can be spaced apart from ones of each pair of discharge electrodes in a direction that is perpendicular with respect to the first substrate, each of said address electrodes can extend in a direction that crosses the pairs of discharge electrodes, each of the address electrodes can surround at least one portion of each discharge cell arranged in a predetermined direction.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a plasma display panel;

FIG. 2 is a partially exploded perspective view of a plasma display panel according to a first embodiment of the present invention;

FIG. 3 is a partial cross-sectional view taken along a line III-III of FIG. 2 according to the first embodiment of the present invention;

FIG. 4 is a layout diagram of discharge cells and first and second discharge electrodes of the plasma display panel illustrated in FIG. 2 according to the first embodiment of the present invention;

FIG. 5 is a partial cross-sectional view of a plasma display panel according to a second embodiment of the present invention;

FIG. 6 is a layout diagram of discharge cells, first and second discharge electrodes, and address electrodes of the plasma display panel illustrated in FIG. 5 according to the second embodiment of the present invention; and

FIG. 7 is a partial cross-sectional view of a plasma display panel according to a third embodiment of the present invention.

### DETAILED DESCRIPTION OF THE INVENTION

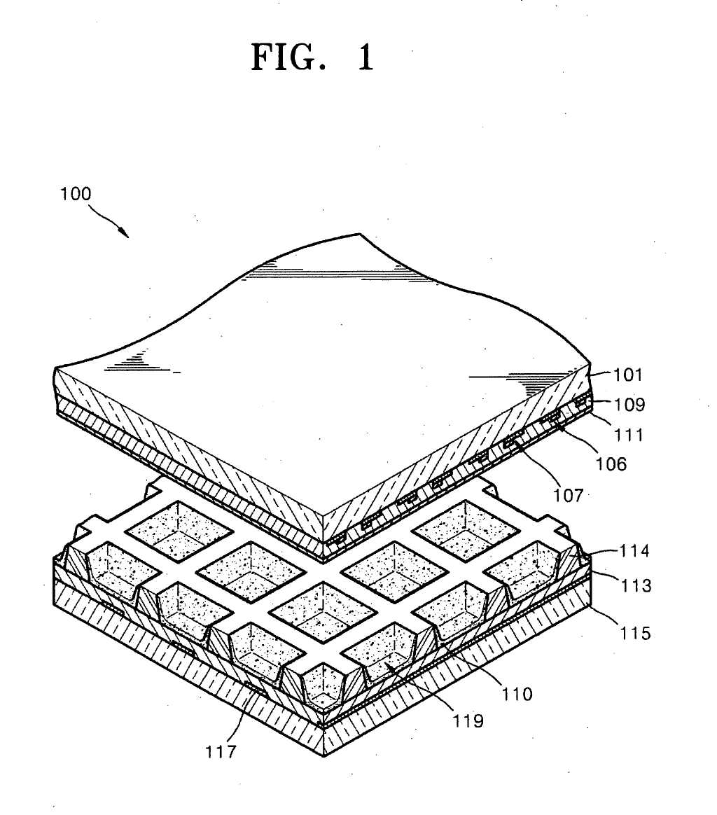

Turning now to the figures, FIG. 1 is an exploded perspective view of a plasma display panel 100. The plasma display panel 100 comprises a first substrate 101, pairs of sustain electrodes 106 and 107, a first dielectric layer 109 on the sustain electrodes 106 and 107, a protective layer 111 on the first dielectric layer 109, a second substrate 115 facing the first substrate 101, address electrodes 117 disposed parallel to each other on the second substrate 115, a second dielectric layer 113 on the address electrodes 117, barrier ribs 114 formed on the second dielectric layer 113, and light-emitting phosphor layers 110 formed on top of the second dielectric layer 113 and sidewalls of the barrier ribs 114. In the PDP 100, since discharge cells 119 are defined and bordered by the barrier ribs 114, impurity gas remaining in the discharge cells 119 cannot be easily expelled.

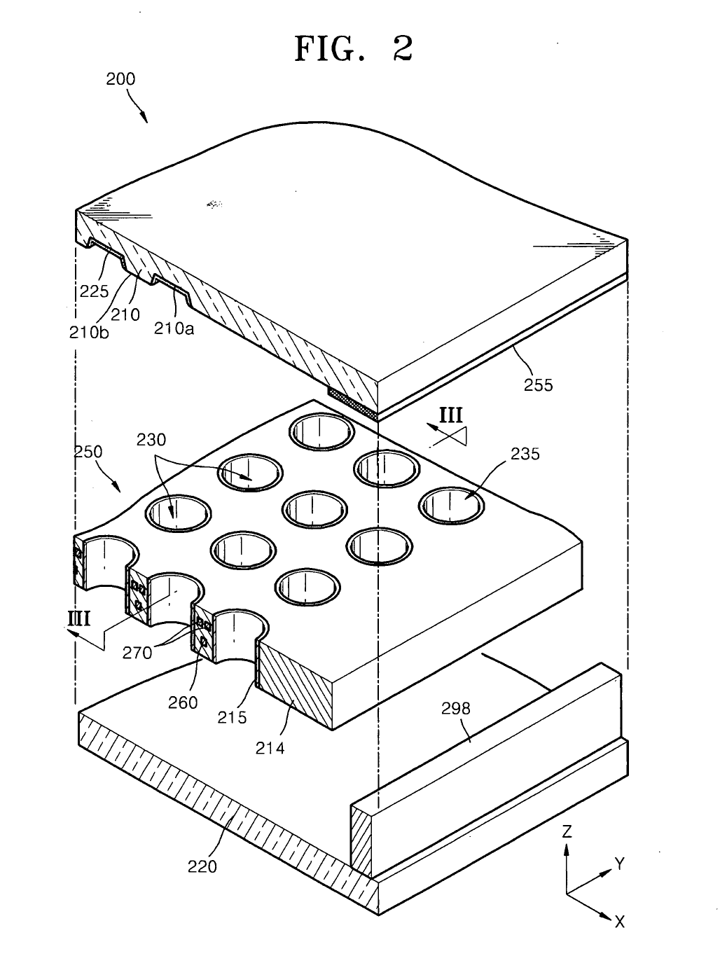

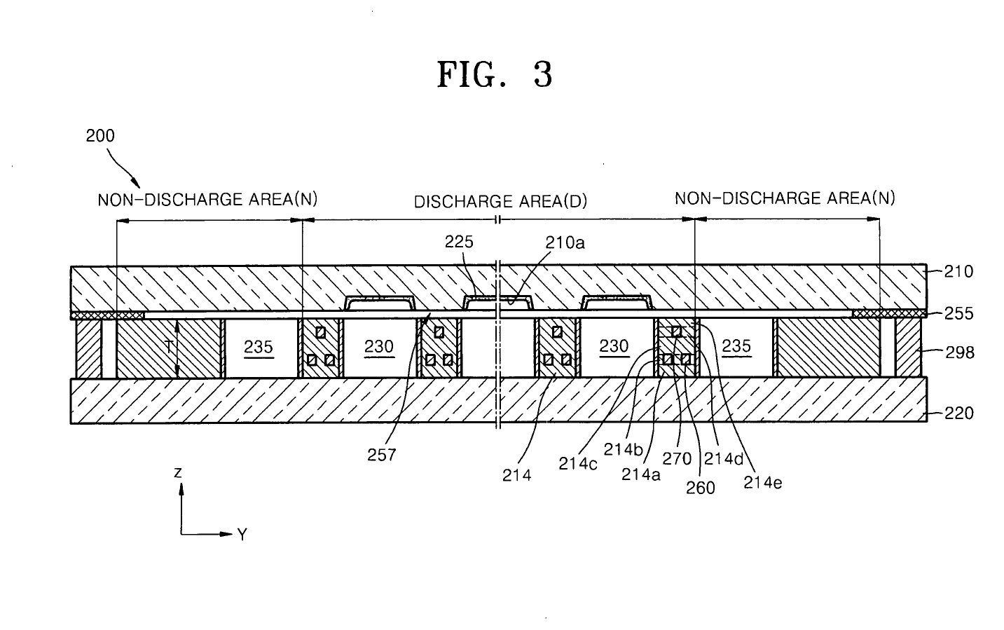

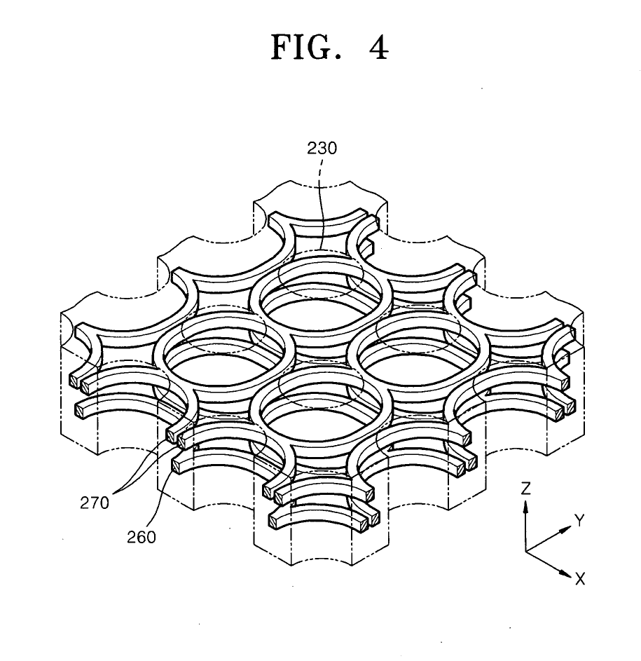

Turning now to FIGS. 2 through 4, FIG. 2 is a partially exploded perspective view of a plasma display panel 200 according to a first embodiment of the present invention, FIG. 3 is a cross-sectional view taken along a line III-III of FIG. 2 of the PDP 200 according to the first embodiment of the present invention and FIG. 4 is a schematic layout diagram of discharge cells 230 and first and second discharge electrodes 260 and 270 of the PDP 200 of FIG. 2 according to the first embodiment of the present invention.

The plasma display panel 200 of FIG. 2 includes a first substrate 210, a second substrate 220, an electrode sheet 250, and phosphor layers 225. The first substrate 210 is normally made out of a material having excellent light transmission properties such as glass. However, the first substrate 210 can be colored in order to increase the bright room contrast by reducing reflective brightness. Also, the second substrate 220 is spaced apart from the first substrate 210, and defines the discharge cells 230 and non-discharge cells 235 which are disposed between the first and second substrates 210 and 220. The second substrate 220 is made out of a material having excellent light transmission properties such as glass, and can be colored, similar to the first substrate 210.

Visible light generated in the discharge cells 230 is transmitted through the first substrate 210. The plasma display panel 100 of FIG. 1 has a low transmission rate of visible light due to sustain electrodes 106 and 107, a first dielectric layer 109, and a protective layer 111 disposed on the first substrate 210. However, in the first embodiment of the present invention, any additional constituents to absorb the visible light can not be disposed on the first substrate 210, except for the phosphor layers 225, and thus, transmission of visible light is remarkably improved over that of PDP 100 of FIG. 1.

Referring to FIG. 2, the electrode sheet 250 includes barrier ribs 214 partitioning the discharge cells 230 and non-discharge cells 235. According to an embodiment of the present invention, the barrier ribs 214 are formed such that the discharge cells 230 and the non-discharge cells 235 have circular cross sections, but the present invention is not limited thereto. That is, the discharge cells 230 and the non-discharge cells 235 can have polygonal cross sections such as triangular cross sections, tetragonal cross sections, pentagonal cross sections, etc. or oval cross sections. Referring to FIGS. 2 and 3, the non-discharge cells 235 surround the discharge cells 230. Therefore, the electrode sheet 250 includes a discharge area D in which the discharge cells 230 are disposed, and a non-discharge area N that surrounds the discharge area D and includes the non-discharge cells 230 and a terminal region (not shown).

The electrode sheet 250 includes a plurality of pairs of the first discharge electrodes 260 and the second discharge electrodes 270. Referring to FIGS. 2 and 3, the first discharge electrodes 260 and the second discharge electrodes 270 are disposed within the barrier ribs 214. The pairs of first discharge electrodes 260 and second discharge electrodes 270 generate discharge within the discharge cells 230. Each of the first discharge electrodes 260 extends in the first or X direction to surround the discharge cells 230 disposed in a first direction X.

The second discharge electrodes 270 extend in a Y direction to surround the discharge cells 230 disposed in a second direction Y which is different from the first direction or X direction in which the first discharge electrodes 260 extend. Also, the second discharge electrodes 270 formed within the barrier ribs 214 are spaced apart from the first discharge electrodes 260 in a direction perpendicular to (i.e., the Z direction) the first substrate 210. According to the first embodiment of the present invention, the second discharge electrodes 270 are disposed closer to the first substrate 210 than the first discharge electrodes 260, but the present invention is not limited thereto.

The plasma display panel 200 according to the first embodiment of the present invention has a two-electrode structure. Accordingly, either the first discharge electrodes 260 or the second discharge electrodes 270 can serve as scan and sustain electrodes, and the others can serve as address and sustain electrodes.

Referring to FIGS. 2 and 3, since the first discharge electrodes 260 and the second discharge electrodes 270 are disposed within the barrier ribs 214, they do not reduce the transmission rate of visible light. Therefore, the first discharge electrodes 260 and the second discharge electrodes 270 can be made out of a conductive metal such as aluminum, copper, etc. Accordingly, since the conductive metal has a small voltage drop, the first discharge electrodes 260 and the second discharge electrodes 270 can transmit signals stably.

The barrier ribs 214 prevent shorting between the first discharge electrodes 260 and the second discharge electrodes 270 and prevent the first discharge electrodes 260 and the second discharge electrodes 270 from being damaged due to direct collisions with positive ions and electrons produced during sustain discharge. Also, the barrier ribs 214 accumulate wall charges by inducing charges. Accordingly, the barrier ribs 214 are made out of dielectric materials.

The electrode sheet 250 further includes protective layers 215 formed on portions of sidewalls of the barrier ribs 214. The protective layers 215 prevent the barrier ribs 214 from being damaged due to plasma particles. Also, the protective layers 215 generate secondary electrons to reduce discharge voltage. The protective layers 215 can be formed by coating magnesium oxide (MgO) on the sidewalls of the barrier ribs 214.

Grooves 210a are formed in portions of the first substrate 210 facing the discharge cells 230. The grooves 510a can be formed in each of the discharge cells 230 or one groove 210a corresponding to a plurality of discharge cells 230 can be formed. Since the thickness of the first substrate 210 is reduced by the grooves 210a, the transmission rate of visible light is improved.

The phosphor layers 225 can be formed in each of the grooves 210a and include red, green and blue light-emitting phosphor layers. The area of the phosphor layers 225 increases due to the grooves 210a, which results in increased brightness and luminous efficiency. The phosphor layers generate visible rays from ultraviolet rays. A phosphor layer formed in a red light-emitting discharge cell has a phosphor such as Y(V,P)O₄:Eu, a phosphor layer formed in a green light-emitting discharge cell has a phosphor such as Zn₂SiO₄:Mn, YBO₃:Tb, and a phosphor layer formed in a blue light-emitting discharge cell has a phosphor such as BAM:Eu.

A spaced layer 255 is formed in portions of the first substrate 210 corresponding to the non-discharge area N of the electrode sheet 250. The spaced layer 255 is formed along the boundary of the first substrate 210 and thus has a closed structure. The electrode sheet 250 is disposed between the spaced layer 255 and the second substrate 220. More specifically, the discharge area D and a portion of the non-discharge area N of the electrode sheet 250 are disposed between the first substrate 210 and the second substrate 220, and other portions of the non-discharge area N are disposed between the spaced layer 255 and the second substrate 220. The electrode sheet 250 substantially has a constant thickness T so that the discharge area D of the electrode sheet 250 is spaced apart from the first substrate 210, thereby forming an exhaustion space 257. The exhaustion space 257 is formed between all the discharge cells 230 so that impure gases can be easily expelled, thereby improving the exhaustion capacity plasma display panel 200.

A sealing member 298 is disposed between the spaced layer 255 and the second substrate 220. The sealing member 298 surrounds the electrode sheet 250 and connects the first substrate 210 to the second substrate 220, and seals within the discharge cells 230. The sealing member 298 can be made out of frit glass. A discharge gas such as Ne, Xe, or a mixture thereof is sealed within the discharge cells 230.

A method of manufacturing the plasma display panel 200 will now be described. The first substrate 210, the second substrate 220 and the electrode sheet 250 are prepared. The first substrate 210 is etched or sandblasted to form the grooves 210a. Phosphor layer pastes are applied to the groove 210a and are then dried and baked to form the phosphor layers 225. The spaced layer 255 can be formed at the same time as the formation of the phosphor layers 225.

The electrode sheet 250 can be manufactured using various methods, one of which will now be described. As shown in FIG. 3, a first dielectric sheet 214a, a second dielectric sheet 214b and having a first discharge electrode 260, a third dielectric sheet 214c, a fourth dielectric sheet 214d and having a second discharge electrode 270, and a fifth dielectric sheet 214e are laminated in sequence, and then dried and baked to form electrode sheet 250. Then a protective layers, 215 is formed on the inner sidewalls of the barrier ribs 214. As described above, the electrode sheet 250 is formed by repeating processes, thereby simplifying the process of manufacturing the plasma display panel 200. When the first substrate 210, the second substrate 220 and the electrode sheet 250 are prepared, the first substrate 210 and the second substrate 220 are sealed together using frit glass. Then the plasma display panel 200 is completed by repeating an exhaustion/discharge gas injection process.

A method of operating the plasma display panel 200 having the above structure will now be described, according to an embodiment of the present invention. An address discharge is generated between the first discharge electrodes 260 and the second discharge electrodes 270, resulting in the selection of the discharge cells 230 that later generate a sustain discharge. Thereafter, when a sustain voltage is applied between the first discharge electrodes 260 and the second discharge electrodes 270 of the selected discharge cells 230, a sustain discharge is generated between the first and second discharge electrodes 260 and 270. The address discharge also serves to reduce an energy level of the discharge gas excited by the sustain discharge, thereby producing ultraviolet rays. The ultraviolet rays excite the phosphor layers 225, such that an energy level of the excited phosphor layers 225 is reduced to emit visible light that forms an image.

The plasma display panel 100 of FIG. 1 has a relatively small discharge area due to the sustain discharge generated perpendicularly to the first substrate 101 between the sustain electrodes 106 and 107, compared to the plasma display panel 200 of the present invention. However, the plasma display panel 200 of the present invention has a relatively large discharge area due to the sustain discharge generated on all sides of the barrier ribs 214. Also, in an embodiment of the present invention, the sustain discharge forms a closed curve along the sidewalls of the barrier ribs 214 and gradually extends to the center of each of the discharge cells 230. Accordingly, the size of the sustain discharge area increases. Also, the sustain discharge is generated mainly at the center of each of the discharge cells 230, which prevents ion sputtering of the phosphor layers 225. Accordingly, residual image does not occur, even when an image is displayed for a long time.

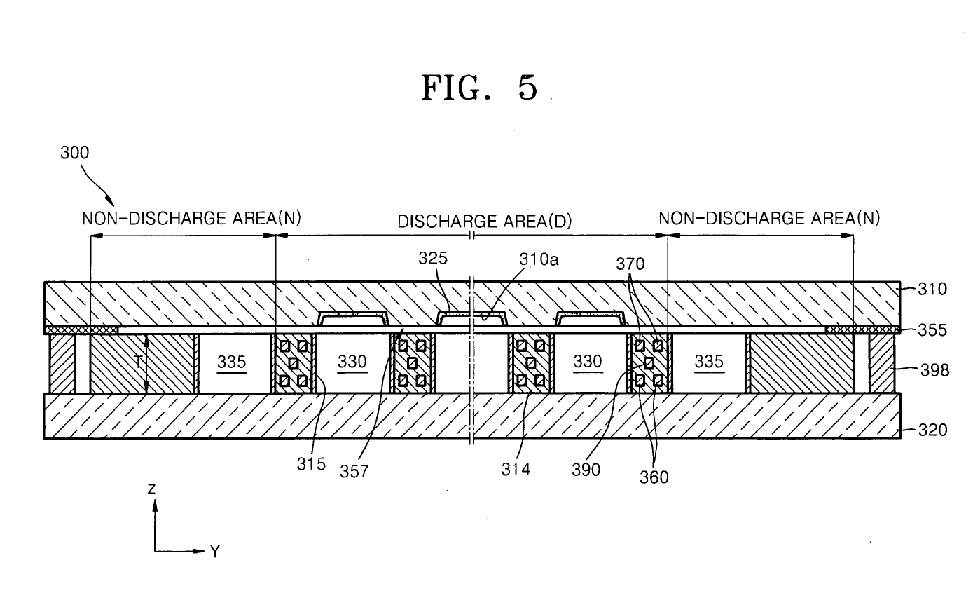

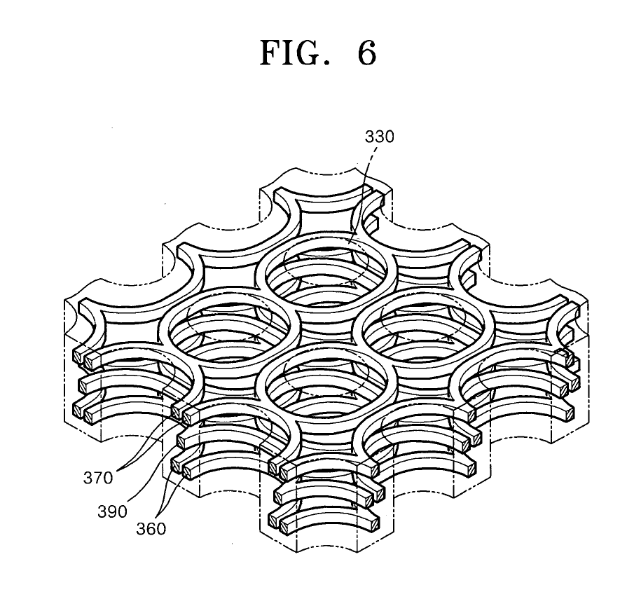

Turning now to FIGS. 5 and 6, FIG. 5 is a partial cross-sectional view of a plasma display panel 300 according to a second embodiment of the present invention and FIG. 6 is a layout diagram of discharge cells 330, first and second discharge electrodes 360 and 370, and address electrodes 390 of the plasma display panel illustrated in FIG. 5. The differences between the plasma display panel 200 of the first embodiment and the plasma display panel 300 of the second embodiment will now is be described.

The plasma display panel 300 includes a first substrate 310, a second substrate 320, an electrode sheet 350, and phosphor layers 325. The first substrate 310 and the second substrate 320 are made out of glass. Referring to FIG. 5, the electrode sheet 350 includes barrier ribs 314 that partition the discharge cells 330 and non-discharge cells 335. The barrier ribs 314 are made out of a dielectric material. The electrode sheet 350 includes a plurality of pairs of the first discharge electrodes 360 and the second discharge electrodes 370. Referring to FIGS. 5 and 6, the first discharge electrodes 360 and the second discharge electrodes 370, formed within the barrier ribs 314, are spaced apart from each other and disposed in a direction perpendicular to (in a direction Z) the first substrate 310. The first discharge electrodes 360 make pairs with the second discharge electrodes 370 and generate plasma within the discharge cells 330. The first discharge electrodes 360 and the second discharge electrodes 370 extend parallel to each other and surround each of the discharge cells 330 disposed in a first direction X.

The electrode sheet 350 further includes address electrodes 390 that cross the first discharge electrodes 360 and the second discharge electrodes 370. The address electrodes 390, formed within the barrier ribs 314, are spaced apart from each of the first-and second discharge electrodes 360 and 370 by a distance in the Z direction perpendicular to the first substrate 310. Each of the address electrodes 390 surrounds each of the discharge cells 330 extending in a second direction Y. Referring to FIG. 5, the second discharge electrodes 370, the address electrodes 390, and the first discharge electrodes 360 are sequentially disposed closer to the first substrate 310 to reduce an address discharge voltage, but the present invention is not limited thereto. The address electrodes 390 can instead be disposed closest to the first substrate 310, or farthest from the first substrate 310, or can be formed on the second substrate 320. The address electrodes 390 generate an address discharge in order to more easily perform a sustain discharge between the first discharge electrodes 360 and the second discharge electrodes 370, and more particularly, to reduce a voltage required to start the sustain discharge. In the current embodiment of the present invention, the first discharge electrodes 360 serve as scan electrodes and the second discharge electrodes 370 serve as sustain electrodes, but the present invention is not limited thereto.

The electrode sheet 350 further includes protective layers 315 formed on portions of sidewalls of the barrier ribs 314. Grooves 310a are formed in portions of the first substrate 310 facing the discharge cells 330. The phosphor layers 325 are formed in each of the grooves 310a and include red, green and blue light-emitting phosphor layers.

A spaced layer 355 is formed in portions of the first substrate 310 corresponding to non-discharge areas N of the electrode sheet 350. The spaced layer 355 is formed along the boundary of the first substrate 310 and thus has a closed structure. The electrode sheet 350 is disposed between the spaced layer 355 and the second substrate 320. More specifically, the discharge area D and a portion of the non-discharge area N of the electrode sheet 350 are disposed between the first substrate 310 and the second substrate 320, and other portions of the non-discharge area N are disposed between the spaced layer 355 and the second substrate 320. The electrode sheet 350 substantially has a constant thickness T so that the discharge area D of the electrode sheet 350 is spaced apart from the first substrate 310, thereby forming an exhaustion space 357. The exhaustion space 357 is formed between all the discharge cells 330 so that impure gases can be easily expelled, thereby improving the exhaustion capacity of the plasma display panel 300.

A sealing member 398 is disposed between the spaced layer 355 and the second substrate 320. The sealing member 398 surrounds the electrode sheet 350, connects the first substrate 310 to the second substrate 320, and seals the discharge cells 330 within. The sealing member 398 can be made out of frit glass. A discharge gas such as Ne, Xe, or a mixture thereof is sealed within the discharge cells 330.

A method of operating the plasma display panel 300 having the above structure will now be described, according to an embodiment of the present invention. An address discharge is generated between the first discharge electrodes 360 and the address electrodes 390, resulting in the selection of the discharge cells 330 for later generation of a sustain discharge. Thereafter, when a sustain voltage is applied between the first discharge electrodes 360 and the second discharge electrodes 370, the sustain discharge is generated between the first and second discharge electrodes 360 and 370 in the selected discharge cells 330. An energy level of the discharge gas excited by the sustain discharge is reduced, thereby producing ultraviolet rays. The ultraviolet rays excite the phosphor layers 325, such that an energy level of the excited phosphor layers 325 is reduced to produce visible light that forms an image.

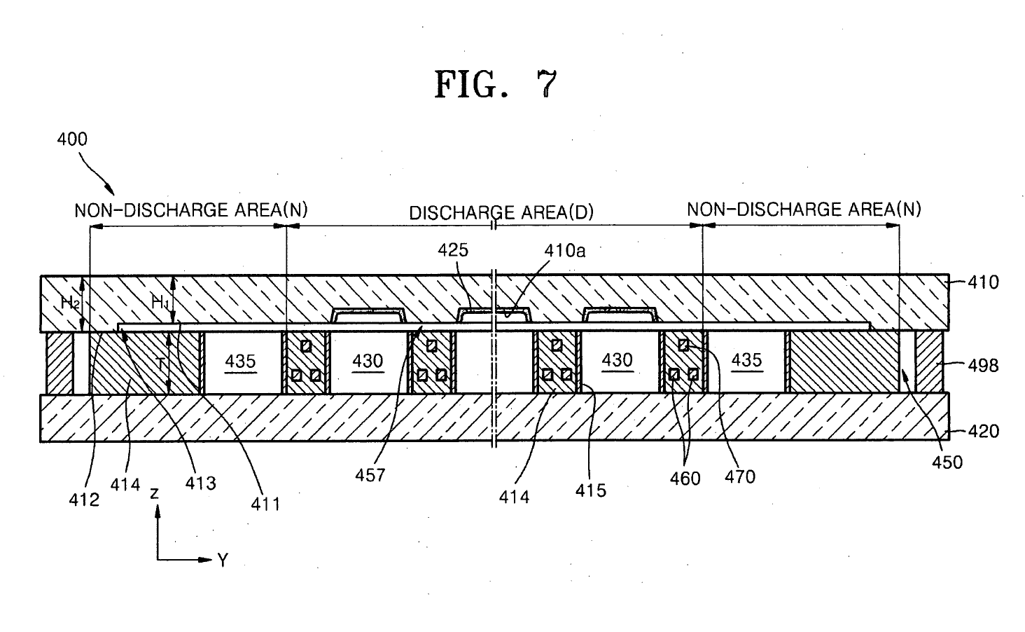

FIG. 7 is a partial cross-sectional view of a plasma display panel 400 according to another embodiment of the present invention. The differences between the plasma display panel 300 of the previous embodiment and the plasma display panel 400 of the current embodiment will now be described. The plasma display panel 400 includes a first substrate 410, a second substrate 420, an electrode sheet 450, and phosphor layers 425. The first substrate 410 and the second substrate 420 are made out of glass.

Referring to FIG. 7, the electrode sheet 450 includes barrier ribs 414 partitioning a plurality of discharge cells 430 and non-discharge cells 435. The barrier ribs 414 are made out of a dielectric material. The electrode sheet 450 includes a plurality of pairs of discharge electrodes, each pair of discharge electrodes including a first discharge electrode 460 and a second discharge electrode 470. The structure and operation of the first and second discharge electrodes 460 and 470 are similar to those of the first and second discharge electrodes 360 and 370 illustrated in FIG. 4 and thus descriptions thereof are omitted. The plasma display panel 400 according to the current embodiment of the present invention has a two-electrode structure but can have a three-electrode structure. For a more detailed description, refer to the first and second discharge electrodes 360 and 370 and the address electrodes 390 illustrated in FIG. 6.

The electrode sheet 450 further includes protective layers 415 formed on portions of sidewalls of the barrier ribs 414. Grooves 410a are formed in portions of the first substrate 410 facing the discharge cells 430. The phosphor layers 425 are formed in each of the grooves 410a and include red, green, and blue light-emitting phosphor layers.

A step height 413 is formed in portions of the first substrate 410 corresponding to non-discharge areas N of the electrode sheet 450. Therefore, the first substrate 410 includes a center part 411 and a circumference part 412 having a greater thickness H₂ than a thickness H₁ of the center part 411 due to the step height 413. The circumference part 412 surrounds the center part 411. Also, the center part 411 corresponds to a discharge area D and a portion of the non-discharge areas N, and the circumference part 412 corresponds to other portions of the non-discharge areas N.

The electrode sheet 450 is disposed between the circumference part 412 of the first substrate 410 and the second substrate 420. The electrode sheet 450 substantially has a constant thickness (T) so that the discharge area D of the electrode sheet 450 is spaced apart from the first substrate 410 by a distance H₂-H₁, thereby forming an exhaustion space 457. The exhaustion space 457 is formed above all the discharge cells 430 so that impure gases can be easily expelled, thereby improving the exhaustion capacity of the plasma display panel 400.

A sealing member 498 is disposed between the circumference part 412 of the first substrate 410 and the second substrate 420. The sealing member 498 surrounds the electrode sheet 450, connects the first substrate 410 to the second substrate 420, and seals within the discharge cells 430. The sealing member 498 can be made out of frit glass. A discharge gas such as Ne, Xe, or a mixture thereof is sealed in the discharge cells 430.

A method of operating the plasma display panel 400 having the above structure according to an embodiment of the present invention is similar to that of the plasma display panel 300 of the previous embodiment and thus a description thereof is omitted.

In the plasma display panel of the present invention, since a first substrate is spaced apart from an electrode sheet so that an exhaustion space is formed above discharge cells, the exhaustion capacity of the plasma display panel is improved.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A plasma display panel, comprising:
a first substrate and a second substrate facing each other;
an electrode sheet arranged between the first substrate and the second substrate and partitioning a space between the first substrate and the second substrate into a plurality of discharge cells, the electrode sheet including a plurality of pairs of discharge electrodes arranged within a plurality of barrier ribs, the plurality of pairs of discharge electrodes adapted to generate a discharge in the plurality of discharge cells, the electrode sheet extending throughout a discharge area where a discharge is generated and into a non-discharge area surrounding at least a portion of the discharge area; and
a spaced layer arranged on portions of the first substrate corresponding to the non-discharge area, wherein at least a portion of the electrode sheet within the discharge area is spaced apart from the first substrate by an exhaustion space and a portion of the electrode sheet in the non-discharge area is arranged between the spaced layer and the second substrate.

2. The plasma display panel of claim 1, wherein the non-discharge area of the electrode sheet surrounds the discharge area.

3. The plasma display panel of claim 2, wherein the spaced layer is arranged along an edge of the first substrate and has a closed shape.

4. The plasma display panel of claim 1, further comprising a sealing layer adapted to combine the spaced layer and the second substrate together and to seal within the plurality of discharge cells.

5. The plasma display panel of claim 1, wherein the electrode sheet has a constant thickness.

6. The plasma display panel of claim 1, wherein a plurality of grooves are arranged on a side of the first substrate that faces the plurality of discharge cells.

7. The plasma display panel of claim 6, further comprising phosphor layers arranged in the plurality of grooves.

8. The plasma display panel of claim 1, wherein each pair of said plurality of pairs of discharge electrodes comprises a first discharge electrode and a second discharge electrode arranged within ones of the plurality of barrier ribs and spaced apart from each other in a direction perpendicular to the first substrate, each first discharge electrode crosses each second discharge electrode, wherein each first discharge electrode and each second discharge electrode surrounds at least one portion of each discharge cell arranged in a predetermined direction.

9. The plasma display panel of claim 1, wherein each pair of said plurality of pairs of discharge electrodes comprises a first discharge electrode and a second discharge electrode arranged within ones of the plurality of barrier ribs and spaced apart from each other in a direction perpendicular to the first substrate, each first discharge electrode and each second discharge electrode extending in a direction parallel to each other, wherein each first discharge electrode and each second discharge electrode surrounds at least one portion of each discharge cell arranged in a predetermined direction.

10. The plasma display panel of claim 9, further comprising a plurality of address electrodes, each of said address electrodes spaced apart from ones of each pair of discharge electrodes in a direction that is perpendicular with respect to the first substrate, each of said address electrodes extending in a direction that crosses the pairs of discharge electrodes, wherein each of the address electrodes surrounds at least one portion of each discharge cell arranged in a predetermined direction.

11. A plasma display panel, comprising:
a first substrate and a second substrate facing each other; and
an electrode sheet arranged between the first substrate and the second substrate and partitioning a space between the first substrate and the second substrate into a plurality of discharge cells, the electrode sheet including a plurality of pairs of discharge electrodes arranged within a plurality of barrier ribs, the plurality of pairs of discharge electrodes adapted to generate a discharge in the plurality of discharge cells, the electrode sheet extending throughout a discharge area where a discharge is generated and into a non-discharge area surrounding at least a portion of the discharge area, wherein at least a portion of the electrode sheet within the discharge area is spaced apart from the first substrate so that a step height is formed in portions of the first substrate corresponding to the non-discharge area of the electrode sheet.

12. The plasma display panel of claim 11, wherein the non-discharge area of the electrode sheet surrounds the discharge area.

13. The plasma display panel of claim 12, wherein the step height is arranged along an edge of the first substrate.

14. The plasma display panel of claim 11, wherein the first substrate comprises a circumference part that surrounds a center part, the circumference part of the first substrate having a greater thickness than that of a center part of the first substrate due to the step height,
wherein the plasma display panel further comprises a sealing layer adapted to connect the circumference part of the first substrate to the second substrate and adapted to seal the discharge cells within.

15. The plasma display panel of claim 11, wherein the electrode sheet has a constant thickness.

16. The plasma display panel of claim 11, wherein a plurality of grooves are arranged on a side of the first substrate facing the discharge cells.

17. The plasma display panel of claim 16, further comprising phosphor layers arranged in the plurality of grooves.

18. The plasma display panel of claim 11, wherein each pair of said plurality of pairs of discharge electrodes comprises a first discharge electrode and a second discharge electrode arranged within ones of the plurality of barrier ribs and spaced apart from each other in a direction perpendicular to the first substrate, each first discharge electrode crosses each second discharge electrode, wherein each first discharge electrode and each second discharge electrode surrounds at least one portion of each discharge cell arranged in a predetermined direction

19. The plasma display panel of claim 11, wherein each pair of said plurality of pairs of discharge electrodes comprises a first discharge electrode and a second discharge electrode arranged within ones of the plurality of barrier ribs and spaced apart from each other in a direction perpendicular to the first substrate, each first discharge electrode and each second discharge electrode extending in a direction parallel to each other, wherein each first discharge electrode and each second discharge electrode surrounds at least one portion of each discharge cell arranged in a predetermined direction.

20. The plasma display panel of claim 19, further comprising a plurality of address electrodes, each of said address electrodes spaced apart from ones of each pair of discharge electrodes in a direction that is perpendicular with respect to the first substrate, each of the address electrodes extend in a direction that crosses the pairs of discharge electrodes, wherein each of the address electrodes surrounds at least one portion of each discharge cell arranged in a predetermined direction.
